(19) United States
(12) Patent Application Publication
(10) Pub. No.: US 2015/0350595 A1
(43) Pub. Date: Dec. 3, 2015

(54) Transform-based methods to transmit the high-definition video

(71) Applicant: Shidong Chen, Irvine, CA (US)

(72) Inventor: Shidong Chen, Irvine, CA (US)

(21) Appl. No.: 14/724,622

(22) Filed: May 28, 2015

Related U.S. Application Data
(60) Provisional application No. 62/005,396, filed on May 30, 2014.

(51) Int. Cl. H04N 7/015; H04N 7/045

(52) U.S. Cl. CPC H04N 7/0155; H04N 7/045

(57) ABSTRACT

The present invention presents the HD video transmission methods, which transmit the HD video into transform domain. In an aspect of the present invention, at the HD video transmitter the HD video is transformed by a multi-dimensional transform. Through the discrete-time continuous-valued or quasi-continuous-valued modulation, the obtained coefficients in transform domain are preferably carried in parallel in a multiple-access channel in time-domain to the HD video receiver.

This application refers to the prior provisional application under application number US 62/005,396 filed on May 30, 2014.

### BACKGROUND OF THE INVENTION

1. Field of Invention

The present invention relates to the video transmission for video surveillance systems, broadcasting systems, machine vision systems and other video systems.

2. Background

Video transmission is a fundamental component and function in many systems and applications. In a typical HD video surveillance system, multiple HD cameras are connected with one video recorder via a cable network. Each camera transmits at least an HD video to the video recorder over the connecting cable. The video recorder often displays the camera video instantly to monitor the live scenes in the field of view of the cameras, records the camera videos and plays back the recordings.

Historically, video transmission system started in analog transmission. The CCTV (closed circuit TV) video surveillance system adapts the CVBS (composite video baseband with synchronization) signal transmission over coax cable, and becomes a worldwide-deployed wired analog video transmission system. Analog transmission adopts analog modulation to carry the analog source video, which is a temporally and vertically discrete-sampled, horizontally continuous and continuous-valued 3-dimensional signal. By the raster-scan method, the source video is converted into the analog transmission signal, which is a continuous-time and continuous-valued 1-dimensional analog signals, such as CVBS, for various transmissions. As digital technologies vastly advance, digital video transmission has replaced or is rapidly replacing the analog video transmission in many applications.

The existing video surveillance systems adopt various methods of HD video transmission to carry the HD videos from the cameras to the video recorder over the cables. In a typical HD IP (Internet Protocol) video surveillance system, the mega-pixel IP camera employs the heavyweight digital video compression technology such as H.264 to compress the digital HD source video down to digital data at a bit rate about 10 Mb/s or below. The digital data of the compressed HD video are wrapped in IP packets and carried by Ethernet cable to the network video recorder. The HD video transmission over IP on Ethernet cable has the well-known disadvantages. First, the transmission distance is limited to 100 meters. Second, the heavyweight compression causes the loss of image quality. Third, the long latency and the varying delay of the video frames carried over IP cause the loss of promptness and smoothness. Fourth, the complexity of IP technology causes the high installation, operation and maintenance cost.

Many applications adapt the uncompressed digital video transmission method. Contrary to HD IP camera, the HD-SDI camera transmits the digital uncompressed, high quality professional grade HD video over coax cable. However due to its high bit rate and non-optimal modulation, the HD-SDI transmission is typically limited to around 100 meter too.

Both HD IP camera and HD-SDI camera adopt digital transmission. Digital video transmission expresses the digital source video, which is a temporally, vertically and horizontally discrete-sampled and discrete-valued 3-dimensional signal, in digital data and adopts digital communication to carry the digital data in the discrete-time and discrete-valued digital transmission signal by various digital modulation methods. The IP cameras with fast Ethernet interface in 100base-TX mode carry the digital data over pulse signal with a set of 3 discrete voltage levels. Others with Gigabit Ethernet interface in 1000base-TX mode carry digital data over pulse signal with a set of 5 discrete voltage levels. HD-SDI camera transmits all digital data of uncompressed digital source video over binary pulse signal with a set of 2 discrete voltage levels. The discrete values, such as the discrete voltage levels, which carry the digital data in digital modulation, are called constellations.

Digital receiver needs to make decisions on which discrete values are transmitted based on received signal that is typically impaired by noise and interference. Usually as the transmission distance increases to certain length, the decision error and thus the digital bit error increase rapidly, and the receiver video quality deteriorates rapidly and becomes unusable. This is called digital cliff effect. While the digital transmission achieves high efficiency by taking the advantages of the advanced digital processing technologies including high efficiency compression and modulation, it inherently suffers from the digital cliff effect. Contrarily, analog video transmission adopts the analog modulation, which generate continuous-time and continuous-valued transmission signal without constellations, and thus degrades smoothly and gradually without such cliff effect as no such decision is made at receiver end. This is called graceful degradation.

In a search for a transmission method with long distance and cost-effectiveness, the analog transmission of HD video has been revived. The latest invented method disclosed in patents [1] [2] adopts the HD analog composite video transmission, referred as HD-CVI. Similar to the CVBS signal (Composite Video Blanking Synchronization), the luminance picture is converted to raster-scanned luma signal, which is then transmitted in baseband. Similar to CVBS, the two chrominance pictures are converted to two raster-scanned chroma signals, which are modulated into a QAM (Quadrature Amplitude Modulation) signal and transmitted in passband. Unlike CVBS, the passband chroma signal locates at higher frequency band so that it does not overlap with baseband luna signal in frequency domain. HD-CVI can carry the HD analog composite video over coax cable for 300 to 500 meters. Due to the nature of analog video transmission, HD-CVI penetrates cable with gracefully degraded video quality.

However, analog transmission methods are unable to take advantages of the advanced digital processing technologies and thus the performance is much limited. First, it is well recognized that the source video has strong spatial and temporal correlation and redundancy. As the HD-CVI method directly converts the 2-dimensional spatial image signal into 1-dimensional temporal signal by raster-scan methods without any compression, the correlation and redundancy are not exploited to improve the video quality of transmission. As a contrast, various digital image compression technologies, including JPEG, JPEG 200, H.264 intra frame coding etc. have been established to exploit the spatial correlation and redundancy and obtain the reconstructed image of relatively high quality at a fractional number of bits compared to the uncompressed image. However, these digital compression technologies do not naturally have the graceful degradation as analog video transmission methods have. Second, modern communication has developed high efficiency modulation technology such as OFDM (Orthogonal Frequency-Division Multiplexing) to better combat the channel impairment. It is not adopted in analog transmission methods.

Therefore, there is a need for new methods to transmit HD video with the graceful degradation, and are capable to exploit the correlation and redundancy of source video as well as high efficiency modulation to achieve high video quality at long distance.

### SUMMARY OF THE INVENTION

The present invention presents the HD video transmission methods, which transmit the HD video into transform domain. In an aspect of the present invention, at the HD video transmitter the HD video is transformed by a multi-dimensional transform. Through the discrete-time continuous-valued or quasi-continuous-valued modulation, the obtained coefficients in transform domain are preferably carried in parallel in a multiple-access channel in time-domain to the HD video receiver.

In an embodiment of the present invention, at the video transmitter the image in each video frame of HD source video is transformed by the 2D-DCT (two-dimensional Discrete Cosine Transform). The obtained DCT coefficients are assigned to the frequency bins of an OFDM symbol according to an OFDMA (Orthogonal Frequency Domain Multiple Access) multiple-access scheme. The OFDM symbol is transformed to time-domain, typically by Inverse FFT (IFFT). The obtained time-domain signal is transmitted over the channel to the HD video receiver. This method is referred as the DCT-OFDMA transmission method. Theoretically, the value s of the DCT coefficients in the DCT-OFDMA transmission method can vary continuously depending on the image signal. When the DCT-OFDMA transmission method is adopted to carry the spatially and temporally discrete-sampled but continuous-valued 3-dimensional source video, referred as sampled video, the DCT-OFDMA method produces continuous-valued DCT coefficients. Thus, opposite to the normal digital OFDM modulation, the values of assigned frequency bins in the DCT-OFDMA transmission method, which are the DCT coefficients, can vary continuously too, without constellations in any way. Such OFDM frequency bins are referred as the continuous OFDM frequency bins. Such OFDM modulation method in the DCT-OFDMA transmission method is referred as the continuous OFDM modulation. In time-domain, the continuous OFDM modulation produces discrete-time but continuous-valued transmission signal. When the sampled video meets the requirement of Nyquist sampling theorem, the original analog video before sampling can be reconstructed from the sampled video without any distortion. Thus, the DCT-OFDMA method in continuous-valued modulation is equivalent to a new analog video transmission method, and can be regarded as the discrete-time implementation of the respective new analog transmission method. Practically, the DCT-OFDMA method is typically adopted to carry digital source video. As the continuous pixel value is typically quantized with high precision when the sampled video is converted to the digital video, the digital pixel value is the digital approximate of the continuous value and varies nearly continuously in certain sense of engineering though mathematically it is discrete. For example, the high precision digital video can be visually indistinguishable with the original analog source video if the quantization noise floor is below the human visual threshold. For another example, the digital video reaches close or nearly identical performance as the original analog video after transmission when the quantization noise floor is close to or below the receiver noise floor. The nearly continuous-valued digital signal that is the digital approximate of a continuous-valued signal is referred as quasi-continuous-valued digital signal, or quasi-continuous digital signal. In addition, a quasi-continuous value can be produced by the computation involving one or multiple quasi-continuous values. Accordingly, when the digital pixel is quasi-continuous-valued, the DCT-OFDMA method produces quasi-continuous-valued DCT coefficients, and further quasi-continuous-valued frequency bins in OFDDM symbol. Such OFDM modulation is referred as quasi-continuous OFDM modulation. In time-domain, quasi-continuous OFDM modulation produces discrete-time but quasi-continuous-valued transmission signal. The DCT-OFDMA method in quasi-continuous-valued modulation is equivalent to the new analog video transmission with quantization noise, and can be regarded as the digital approximate implementation of the respective new analog transmission with limited number of bits precision. In certain embodiment of the present invention, some frequency bins of the OFDM symbol are used to carry the digital data bits with constellations in digital modulation. These frequency bins are referred as the digital OFDM frequency bins. In contrast to a quasi-continuous OFDM frequency bin, a digital OFDM bin is exactly discrete-valued without any approximation as the exact discrete value is selected from the digital constellations. In practical system, the quasi-continuous modulation often prefers high precision and huge set of discrete values to better approximate the continuous modulation while the digital modulation is often limited to small set of discrete values to keep decision error rate low or nearly zeros. For example, when the digital DCT coefficient is approximated by 12 bit, the quasi-continuous complex OFDM bin has a set of 16 million discrete values while a digital OFDM bin with QPSK (Quadrature Phase-Shift Keying) modulation has a set of 4 discrete values only.

In another embodiment of the present invention, at the HD video transmitter the image of each video frame of the HD video is transformed by the spatial 2D-DCT (two-dimensional Discrete Cosine Transform). The obtained DCT coefficients are assigned to the different spreading codes or spreading sequences according to a CDMA (Code Domain Multiple Access) multiple-access scheme, and modulate the assigned spreading sequences by arithmetic multiplication with their spreading sequences respectively. All modulated sequences are summed together and the combined CDMA signal is transmitted in time-domain to the HD video receiver. This method is referred as the DCT-CDMA transmission method. Similarly, in theory, the values of the DCT coefficients in the DCT-CDMA transmission method can vary continuously depending on the video signal. When the DCT-CDMA method is adopted to carry the sampled video, the method produces continuous-valued DCT coefficients. After assignment, opposite to the normal digital CDMA modulation, the baseband signal (to-be-spread signal) value to be multiplied with the spreading sequences, and the amplitude of the modulated sequences after multiplications in DCT-OFDMA transmission method, can vary continuously too, without constellations in any way. These spreading sequences are referred as the continuous CDMA spreading sequences. Such CDMA modulation method in the DCT-CDMA transmission method is referred as the continuous CDMA modulation. Practically, when the DCT-CDMA transmission method is adopted to carry digital source video, it generates quasi-continuous-valued DCT coefficients, and the discrete-time but quasi-continuous-valued transmission signal. Such CDMA modulation with quasi-continuous-valued baseband signal or to-be-spread signal is referred as the quasi-continuous CDMA modulation. In certain embodiment of the present invention, some spreading sequences are used to carry the digital data bits with constellations in digital modulation. These spreading sequences are referred as the digital CDMA sequences.

For purpose of brevity, the following description does not strictly differentiate continuous-valued or quasi-continuous-valued modulation, and may disclose the method of present invention in either one.

In certain embodiment of the present invention, at the HD video transmitter each image of HD video is divided into small transform blocks, such as 8×8 pixel square blocks or 16×16 pixel square blocks, where 8×8 pixel denotes 8 pixel wide by 8 pixel high, same to 16×16 pixel. Each block is a called transform block. The spatial transform is conducted on each transform block of the original image, and thus converts each transform block into a DCT coefficient block of same size.

In another embodiment of the present invention, at the HD video transmitter, not the original source video but the residual video generated by the predictive coding from the source video is transmitted. At the HD video transmitter after each image of HD video is divided into small transform blocks, the HD video transmitter generates a prediction block for each transform block. The prediction block is subtracted away from the original transform block to produce a residual transform block, and each residual transform block is converted into a DCT coefficient block of same size. There are various methods to generate the prediction block. In an embodiment of the present invention, the HD video transmitter generates a prediction block from the already processed neighboring transform blocks in same image according to a certain prediction method, such as the intra-frame prediction in H.264 encoder and others. In another embodiment of the present invention, the HD video transmitter generates a prediction block from the transform blocks in the already processed and transmitted past, or future, or both images according to a specific prediction method, such as the inter-frame prediction in H.264 encoder and others. The methods to generate the prediction are beyond the scope of the present invention.

Due to the nature of the uncompressed images in the source video, the DC coefficient produced by 2D-DCT, whose horizontal and vertical DCT frequency are both zero, is often large. In an embodiment of the present invention, at the HD video transmitter a DC coefficient prediction is generated from the pixels in the already processed blocks. The original DC coefficient is subtracted by the predicted DC coefficient. The predicted DC coefficient can be shrunk by a factor less than 1 to reduce error propagation. The residual DC coefficient is passed on for further processing in same way as the other AC coefficients, whose horizontal or vertical spatial frequency is not zero. In another embodiment of the present invention, the residual DC coefficient is further quantized, coded and transmitted by digital modulation, as in the DPCM coding of DC coefficient in JPEG or others. These methods are referred as the differential encoding of the DC coefficient. After the differential encoding of the DC coefficient, a DCT coefficient block includes a residual DC coefficient and all AC coefficients, or all AC coefficients only if DC coefficient is encoded digitally. Without the differential encoding of the DC coefficient, a DCT coefficient block includes a DC coefficient and all AC coefficients. The methods to generate the prediction of DC coefficient are beyond the scope of the present invention.

In an embodiment of the present invention, at the HD video transmitter the obtained DCT coefficients are not digitally quantized, but are directly assigned to the quasi-continuous modulation. Though the DCT coefficients are usually represented by digital signal with limited number of bits, the digital coefficient signal is a representation of quasi-continuous value with limited precision. Therefore, without further digital quantization, the full-precision digital coefficient signal is sent to the quasi-continuous modulation. In another embodiment of the present invention, the obtained DCT coefficients are digitally quantized according to the specific quantization tables, such as those defined in JPEG, and then the quantized DCT coefficients are assigned to the quasi-continuous modulation. In yet another embodiment of the present invention, some small DCT coefficients are zeroed if their magnitudes fall below a specific threshold, while other large DCT coefficients are passed without quantization. All zero and zeroed DCT coefficients are referred as zero DCT coefficients thereafter in present invention.

In a certain embodiment of the present invention, at the HD video transmitter the neighboring DCT coefficient blocks are grouped together into normalization regions. A normalization region can include one DCT coefficient block, multiple DCT coefficient blocks, or all DCT coefficient blocks in the whole image. Each coefficient in the normalization region is scaled by such a number referred as the scaling factor. The scaling factor can be set so that the average weighted square sum of all DCT coefficients in the normalization region or the peak value of the time-domain signal generated from the normalization region equals to or is close to a specific value. The scaling factor(s) is (are) transmitted to the video receiver as meta-data in digital data to scale the nominalization region back.

In an embodiment of the present invention, the DCT coefficients are assigned to the quasi-continuous OFDM frequency bins in the DCT-OFDMA transmission method. The process is referred as the mapping. There are various mapping methods. In a certain embodiment of the present invention, at the HD video transmitter the neighboring DCT coefficient blocks are grouped together into transmission regions. The DCT coefficients in all DCT coefficient blocks inside the same transmission region are mapped in parallel into the quasi-continuous frequency bins of same OFDM symbol. The transmission region can include one DCT coefficient block or multiple DCT coefficient blocks, depending on the size of transform block and the number of usable frequency bins per OFDM symbol. In another certain embodiment of the present invention, a zigzag scan, such as the one in JPEG or H. 264, converts all DCT coefficients in the two-dimensional DCT coefficient block into one-dimensional array, referred as the block coefficient array. Then all block coefficient arrays in same transmission region are interleaved to generate a region coefficient array that includes all DCT coefficients in the region. Lastly, all DCT coefficients in the region coefficient away are assigned to the quasi-continuous frequency bins of same OFDM symbol according to specific mapping method.

There are various mapping methods to assign the region coefficient array to the OFDM symbol. In an embodiment of the present invention, the DCT coefficients in the region coefficient array are assigned to the quasi-continuous OFDM bins sequentially so that the DCT coefficient with lowest spatial frequency is assigned to the quasi-continuous OFDM frequency bin with lowest time-domain frequency. In another embodiment of the present invention, all non-zero DCT coefficients in the region coefficient array are assigned to the quasi-continuous OFDM frequency bins in the DCT-OFDMA transmission method while the zero DCT coefficients are skipped. The number of skipped zero coefficients before each non-zero coefficient in mapping is sent in the digital OFDM bins to the HD video receiver. In yet another embodiment of the present invention, the non-zero DCT coefficients in the array are assigned to the quasi-continuous OFDM frequency bins in the DCT-OFDMA transmission method in such a specific order that the non-zero DCT coefficient with largest magnitude is assigned to the quasi-continuous OFDM frequency bin with lowest time-domain frequency. The zero DCT coefficients are skipped. The location information of non-zero coefficients is sent in the digital OFDM bins to the HD video receiver. This is referred as the largest to the lowest mapping

In another embodiment of the present invention, the DCT coefficients are assigned to the quasi-continuous spreading sequences in the DCT-CDMA transmission method. If the spreading sequences of CDMA do not have flat spectrum, i. e. are not white, such as the orthogonal Walsh codes, the OFDMA mapping methods apply similarly to the CDMA mapping. If the spreading sequences of CDMA have flat spectrum, i.e. are white, such as the pseudo-random sequences, some method such as the largest to the lowest mapping method in the OFDMA mapping do not apply to the CDMA mapping while others apply.

In an embodiment of the present invention, each OFDM symbol is converted to time-domain and then padded with CP (Cyclic Prefix), CS (Cyclic suffix) or ZP (Zero Padded) as commonly practiced in the digital OFDM modulation. In another embodiment of the present invention, each OFDM symbol is not padded with CF, CS or ZP,

In an embodiment of the present invention, the obtained time-domain transmission signal is complex-valued at baseband. The complex baseband signal is up-converted to passband to transmit over channel, such as wireless channel. In another embodiment of the present invention, the obtained time-domain transmission signal is real-valued in baseband and is directly transmitted in baseband over channel, such as a coax cable. The OFDM modulation with real-valued baseband signal is referred as DMT (Discrete Multi-Tone) in some literatures. For the purpose of simplicity, DMT is not differentiated and is included in OFDM in the description of the present invention if it is not explicitly mentioned.

There are many variations of the present invention. In an embodiment of the present invention, similar to the digital video transmission system adopting 3-dimensional (3-D) DCT, at the video transmitter the digital source video is divided into video segments and each video segment is divided into 3-dimensional rectangular cuboid or cube blocks, such as 8×8×8 pixel cube block, where 8×8×8 pixel denote 8 pixel wide, 8 pixel high and 8 video frame long in time. Each 3-D block is transformed by the 3D-DCT. The obtained DCT coefficients are assigned to the frequency bins in DCT-OFDMA method or the spreading sequences in DCT-CDMA method.

In certain embodiment of the present invention, at the video transmitter the transmission signal the presented methods generate includes more than one output, called multi-output transmission signal. Typically, the multi-output transmission signal is carried over a MIMO (multi-input multi-output) channel, such as a wireless video transmission system with 4 transmitter antennas and 4 receiver antennas under certain constraints, or a Cat5/Cat6 Ethernet cable with 4 drivers where each drives a separate pairs of UTP wires in the cable and each pair of UTP wires are received separately. In one embodiment of the present invention, multiple OFDM symbols are assembled in parallel at same time from the DCT coefficients, and multi-output signal is generated from the multiple paralleling OFDM symbols by multiple paralleling Inverse FFTs. Each output is sent to a separate driver or antenna.

It is to be noted that it is well within the principle and the scope of the present invention that various transform other than DCT, including but not limited to the DWT (Discrete Wavelet Transform) and the DFT (Discrete Fourier Transform), can be adopted to convert the image or video signal into transform domain, various multiple-access scheme other than OFDMA and CDMA can be adopted to carry the coefficients of spatial transform in parallel. The present invention applies to HD or lower definition or higher definition video, and to black and white or color video.

### BRIEF DESCRIPTION OF THE DRAWINGS

FIG. 1 illustrates the video frame timing of an example HD 720p60 video in YUV4:2:0 format.

FIG. 2 illustrates an embodiment of how an example HD image is partitioned into slices and regions in the present invention.

FIG. 3 illustrates an embodiment of how a region is partitioned into macro-blocks in the present invention.

FIG. 4 illustrates an embodiment of how a macro-block is partitioned into transform blocks.

FIG. 5 illustrates an embodiment of the presented methods of HD video transmission.

FIG. 6 illustrates an embodiment of the transmitted signal in a video frame period of the DCT-OFDMA for the example HD video 720p60.

### DETAILED DESCRIPTION OF THE INVENTION

The principle and embodiments of the present invention will now be described in detail with reference to the drawings, which are provided as illustrative examples so as to enable those skilled in the art to practice the invention. Notably, the figures and examples below are not meant to limit the scope of the present invention to a single embodiment but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice versa, unless explicitly stated otherwise herein. Moreover applicants do not intend for any term in the specification or claims to be ascribed an uncommon or special meaning unless explicitly set forth as such. Further, the present invention encompasses present and future known equivalents to the components referred to herein by way of illustration.

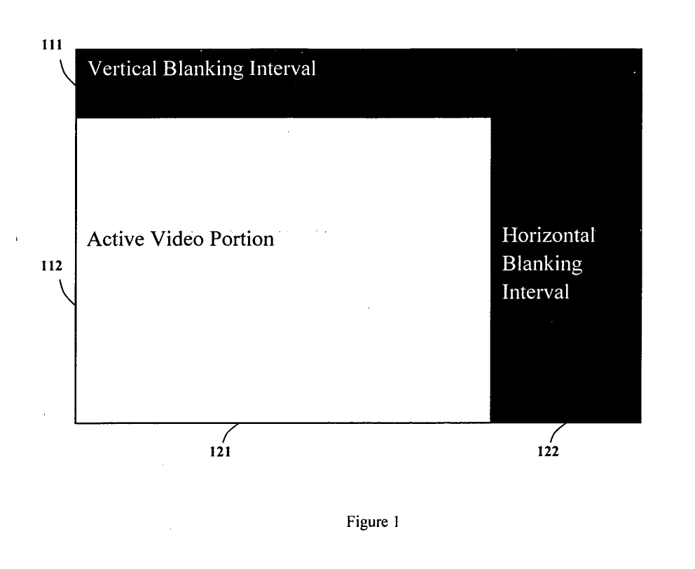

In the following description, the HD video 720p60 in color format YUV4:2:0, as shown in FIG. 1, is assumed for the original source video as an example to illustrate the principle and an embodiment of the present invention. The HD 720p60 has 60 progressive scanned video frames per second. The period of each video frame is 1/60 second, as represented by the outmost rectangle in FIG. 1. Each video frame has 750 scan lines. The first 30 scan lines are vertical blanking lines, whose duration is referred as the vertical blanking interval 111. The rest 720 scan lines are active video lines, whose duration is referred as the vertical active interval 112. Each scan line has 1650 samples when it is sampled at 74.25 MHz frequency. The last 370 samples of each scan line is the horizontal blanking, whose duration is referred as the horizontal blaming interval 122, and the front 1280 samples of each active video line, whose duration is referred as the horizontal active interval labeled as 121, carry the active 1280 luma pixels. All active luma pixels in all active video lines, i. e. the pixels in the active video portion, represent an HD luma image Y of 1280×720 pixels of a video frame. Due to the horizontal and vertical chroma sub-sampling of factor of 2, the two chroma images, U and V, are 640×360 pixels only.

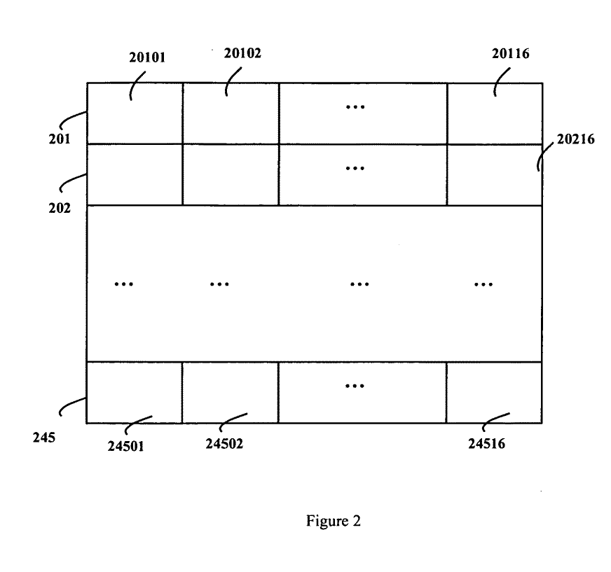

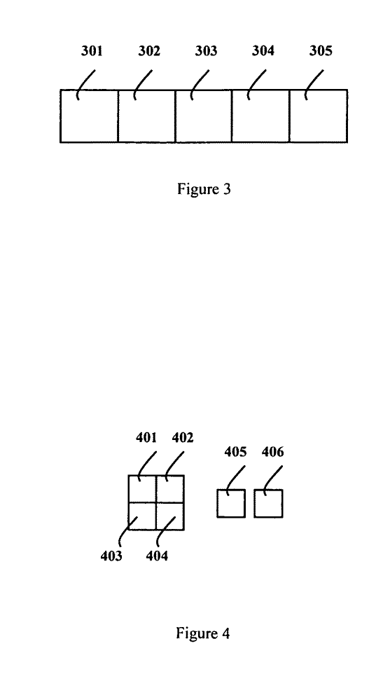

In the illustrated embodiment of the present invention, the HD 1280×720 image of each video frame is partitioned into transform blocks, normalization regions and transmission regions, as shown in FIGS. 2 to 4, in preparation for the following processing steps of the transmission methods of the present invention. First, the HD 1280×720 image is partitioned into 45 horizontal slices, labeled as 201, 202 . . . , 245 from top to bottom respectively as shown in FIG. 2. Each horizontal slice is 1280×16 pixels. Second, each slice is divided into 16 regions, labeled as 20101 20102 . . . , 20116 from left to right in the first slice 201, and so on to 24501, 24502 . . . , 24516 in the last slice 245. Each region is 80×16 pixels. These regions are adopted as both the normalization regions and the transmission regions in the illustrated embodiment of the presented transmission methods. Third, each region is divided into 5 macro-blocks, labeled as 301, 302, . . . , 305 from left to right, as shown in FIG. 3. Each macro-block is 16×16 pixels. Last, each macro-block includes a luma image of 16×16 pixels and two chroma image of 8×8 pixels. The 16×16 pixel luma image is divided into 4 luma blocks. Each luma block is 8×8 pixels, labeled as 401, 402, 403 and 404 respectively in FIG. 4. The two 8×8 pixel chroma blocks are labeled as 405 and 406 respectively. The 8×8 pixel block is adopted as the transform block in the illustrated embodiment of the present invention.

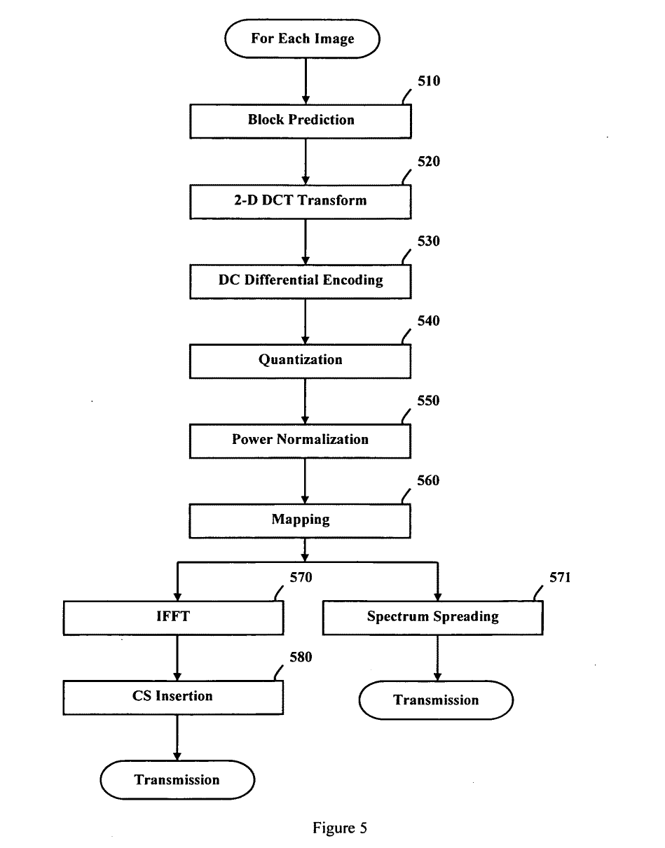

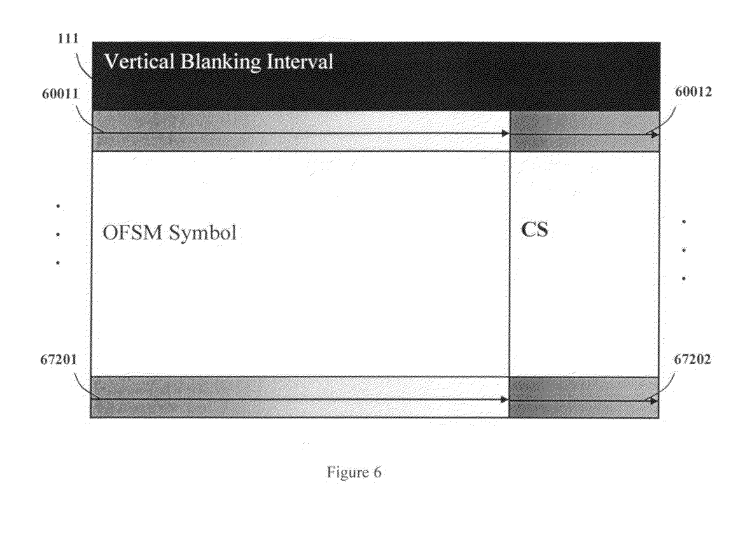

FIG. 5 shows an embodiment of the presented methods of HD video transmission. The presented transmission methods are performed on the image of each video frame of the source video in following steps after it is partitioned as mentioned above:

Step 1. The block prediction step 510 is optional. In the illustrated embodiment of the present invention, for each 8×8 original image block, the block prediction step 510 generates an 8×8 pixel prediction block from the pixels in same image or in past/future images. The prediction block is subtracted from the original image block to produce a residual image block. There are various methods to generate the prediction block. These methods are beyond the scope of the present invention and are not detailed.

Step 2. In the illustrated embodiment of the present invention, the 2D-DCT transform step 520 converts each 8×8 pixel original or residual image block into the transform domain depending if the optional block prediction is present, and produces the DCT coefficient block of same size. The order of blocks for spatial transform can vary. In a certain embodiment of the present invention, in order to minimize processing latency, all blocks in first region 20101 are transformed first, then the next region 20102 is transformed, and so on the last region 24516.

Step 3. The DC differential encoding step 530 is optional. In the illustrated embodiment of the present invention, the step 530 generates a prediction value for the DC coefficient and subtracts the prediction value from the original DC coefficient to produce a residual DC coefficient. The residual DC coefficient is digitally quantized and encoded into digital bits. There are various methods to generate the prediction for DC coefficient and to encoding the residual DC coefficient, such as the differential DC encoding in JPEG standard. These methods are beyond the scope of the present invention and are not detailed, as these are well known to those who are skilled in this.

Step 4. The quantization step 540 is optional. In one embodiment of the present invention, the DCT coefficients are digitally quantized according to specific quantization tables. In another embodiment of the present invention, the small DCT coefficients whose magnitudes are below a specific threshold are zeroed while other larger ones are passed without any digital quantization.

Step 5. The normalization step 550 is optional. In the illustrated embodiment of the present invention, the normalization step multiplies all DCT coefficients in same normalization region with same number, referred as scaling factor. In the illustrated embodiment of the present invention, the average weighted square sum is calculated over each DCT coefficient block and further over all DCT coefficient blocks in the same normalization region. The average weighted square sum is compared to a specific value and such a scaling factor is determined and applied to each DCT coefficient in the region that the average weighted square sum after scaling is equal or close to a specific value. The scaling factor is carried in digital data bits. As to the example HD video 720p60 in YUV4:2:0 format, the luma and chroma may be normalized separately by their scaling factors. The luma average weighted square sum is calculated over 20 luma blocks in the region while the two chroma average weighted square sums are calculated over 5 chroma blocks of same kind. The luma and chroma blocks are scaled separately by their scaling factors. All 3 scaling factors are carried in digital data bits.

Step 6. In the illustrated embodiment of the present invention, a simple mapping method 560 is adopted. Each 8×8 DCT coefficient block in the region is zigzag-scanned into a one-dimensional block coefficient array of 64 elements. There are 30 block coefficient arrays in the region. All block coefficient array are interleaved to produce a one-dimensional region coefficient array of 1920 elements. The first element of first block coefficient array goes to first element of the region coefficient array. The second element of first block coefficient array goes to 31^{st} element of the region coefficient array and so on. The interleaving order is given by following formula

index of region coefficient array=(index of block coefficient array−1)*30+index of coefficient block

where the index of region coefficient array is an integer in range from 1 to 1920, the index of block coefficient array is an integer in range from 1 to 64, and the index of coefficient block is an integer in range from 1 to 30.

In the illustrated embodiment of DCT-OFDMA transmission method, the mapping 560 sequentially assigns all 1920 real elements in the region coefficient array onto the real and imaginary parts of 960 quasi-continuous OFDM frequency bins from low to high frequency. The sequential assignment may not be consecutive as some OFDM bin may be reserved, and some may be assigned to fixed or moving pilots, or digital modulation. The digital data bits are assigned to digital OFDM bins with constellations.

In the illustrated embodiment of DCT-CDMA transmission method, the mapping 560 sequentially assigns all 1920 real elements in the region coefficient array onto 1920 real quasi-continuous CDMA spreading sequences. Alternatively, the mapping 560 can also pair all 1920 real elements into 960 complex values and assign them to 960 quasi-continuous CDMA spreading sequences. Similarly, the digital data bits are assigned to digital CDMA spreading sequences with constellations.

Step 7. In the illustrated embodiment of DCT-OFDMA transmission method, the IFFT step 570 converts the OFDM symbol from frequency domain to time-domain. Depending on the channel, either 1024-point complex IFFT or 2048-point real IFFT can be chosen. In the case that the channel is a single coax cable, the signal is transmitted in real value in baseband. The 2048-point real IFFT is chosen. In order to produce real-valued signal in time-domain, the IFFT fills the other half of frequency bins by conjugate symmetric operation or equivalent. After IFFT, 2048-sample waveform is generated in real value. As to the example HD 720p60 video in YUV4:2:0 format, when the sampling frequency of the time-domain 2048-sample real-valued waveform is 118.8 MHz, the duration of OFDM symbol exactly equals to the horizontal active interval 121 on each active video scan line.

In the illustrated embodiment of DCT-CDMA transmission method, the spectrum spreading step 571 multiplies each DCT coefficient with the assigned spreading sequence. As mentioned above, this is quasi-continuous modulation carried by the arithmetic multiplication as the DCT coefficient has the quasi-continuous values, though it has limited number-of-bit representations of the quasi-continuous values in digital signal processing circuits. The modulated spreading sequences are summed together to generate the CDMA signal. In the illustrated HD 720p60 video in YUV4:2:0 format, when the 2048-point Orthogonal Walsh Codes are adopted, and the sampling frequency of the time-domain 2048-sample real-valued sequence is 118.8 MHz, the duration of CDMA sequences exactly equals to the horizontal active interval 121 on each active video scan line. During the horizontal blanking interval 122 and vertical blanking interval 111, various choices of transmission exist. For example, the transmitter can transmit the synchronization and blanking signal in original raster-scanned HD video signal. The transmitter can transmit some auxiliary signal such as certain training signal. The transmitter can be disabled. These choices are not detailed, as these are well known to those who are skilled in this. Before transmission, the obtained time-domain CDMA signal is either up-converted to and then transmitted in passband, or directly transmitted in baseband on the channel to the HD video receiver. It is common that some or all steps in the illustrated embodiment of the DCT-CDMA transmission method are carried out by digital circuits. Therefore, the digital representation of signal is converted to analog signal by digital-to-analog converter before it is transmitted onto the channel.

Step 8. In the illustrated embodiment of DCT-OFDMA transmission method, the CS insertion step 580 inserts CS after each OFDM symbol. In the case that the channel is a single coax cable, when the 2048-point real IFFT at 118.8 MHz sampling frequency is adopted, the CS duration is exactly as long as the horizontal blanking interval 122, which is 592 samples at 118.8 MHz sampling frequency. The first 592 samples of the OFDM symbol are repeated immediately after the OFDM symbol. Similarly, during the vertical blanking interval 111, various choices of transmission exist. For example, the transmitter can transmit the synchronization and blanking signal in original raster-scanned HD video signal. The transmitter can transmit some auxiliary signal such as certain training signal. The transmitter can be disabled. These choices are not detailed, as these are well known to those who are skilled in this. Also, the obtained time-domain OFDM signal is either up-converted to and then transmitted in passband, or directly transmitted in baseband on the channel to the HD video receiver. It is common that some or all steps in the illustrated embodiment of the DCT-OFDMA transmission method are carried out by digital circuits. Therefore, the digital representation of signal is converted to analog signal by digital-to-analog converter before it is transmitted onto the channel.

FIG. 6 shows an embodiment of the transmitted signal in a video frame period of the DCT-OFDMA transmission method for the example HD video 720p60. During the vertical blanking interval 111, i.e. the first 30 scan lines, the active video is not transmitted, as it is not in original raster-scanned video signal. During each active video line period, i.e. line period 31 to 750, an OFDM symbol carrying the information of 80×16 pixel image is transmitted in the horizontal active interval 121 and a CS of that OFDM symbol is transmitted in the horizontal blanking interval 122 of same scan line period. The first OFDM symbol, labeled as 60011, carries the image information of first region 20101 in first slice 201, and its CS, labeled as 60012, immediately follows and so on. The last OFDM symbol, i.e. the 720^{th} OFDM symbol, labeled as 67201, carries the image information of last region 24516 in last slice 245, and its CS, labeled as 67202, immediately follows.

It is to be noted that in the illustrated embodiment of the present invention, different OFDM sampling frequency can be selected. The lower OFDM sampling frequency causes the duration of the OFDM symbol to be longer and accordingly the duration of CS to be shorter, and vise versa.

It is worth to note that the illustrated embodiment of the presented transmission methods in present invention do not incur variable processing delay, but fixed processing delay as all DCT coefficients are carried by quasi-continuous modulation. Assuming the input is raster-scanned HD video signal, the theoretic minimum delay in the illustrated embodiment of the present invention is 16 scan line period for the HD video transmitter. Assuming output is raster-scanned HD video signal, the theoretic minimum delay is 16 scan line period for the HD video receiver. The total theoretic minimum end-to-end delay is 32 scan line period.

It is further to be noted that though the present invention is described according to the accompanying drawings, it is to be understood that the present invention is not limited to such embodiments. Modifications and variations could be effected by those skilled in the art without departing from the spirit or scope of the invention as defined in the appended claims. The illustrated embodiments of the present invention only serve as examples of how to apply the present invention to transmit the HD video. There are various embodiments of the present invention. These embodiments are not detailed, as these can be derived by those who are skilled in this.

### REFERENCE

[1] Jun Yin et al., Method and device for transmitting high-definition video signal, Pub. No. CN102724518A, CN1027245188, W02013170763A1, May 6, 2012
[2] Jun Yin et al., Method and device for high-definition digital video signal transmission, and camera and acquisition equipment, Pub. No. CN1027245 19A, CN 102724519 B, W02013170766A1. May 6, 2012

I claim:

1. A method to transmit video, comprising:
dividing the pixels of the video into one or a plurality of transform blocks;
transforming each transform block into a transform coefficient block;
mapping the transform coefficients to one or a plurality of to-be-modulated signal frames; and
modulating each to-be-modulated signal frame to a transmission signal frame,
wherein the video includes but is not limited to one or a plurality of sampled videos whose pixels are continuous-valued or digital videos whose pixels are quasi-continuous-valued,
wherein each transform block includes a plurality of pixels of the video,
wherein each transform coefficient block includes a plurality of transform coefficients,
wherein each to-be-modulated signal frame includes at least one continuous-valued or quasi-continuous-valued transform coefficient, and
wherein each transmission signal frame includes a plurality of discrete-time continuous-valued or quasi-continuous-valued samples to be transmitted consecutively over time.

2. The method of claim 1,
further comprising generating a residual transform block from each transform block, which comprising: generating a prediction block for each transform block; and subtracting each prediction block from the transform block that the prediction block is generated for, and
wherein the transforming transforms each residual transform block into a transform coefficient block.

3. The method of claim 1,
further comprising generating a residual transform coefficient block from each transform coefficient block, which comprising: generating a prediction coefficient block for each transform coefficient block; and subtracting each prediction coefficient block from the transform coefficient block that the prediction coefficient block is generated for, wherein each residual transform coefficient block includes a plurality of residual transform coefficients, and
wherein the mapping maps the residual transform coefficients into one or plurality of to-be-modulated signal frames.

4. The method of claim 1
wherein each transform block includes a two-dimensional transform block that is a rectangular pixel block or a square pixel block with W pixels wide by H pixels high, where W and H are positive integers larger than 1,
wherein the dividing divides the video into one or a plurality of video frames and further divides the image of each video frame into one or plurality of two-dimensional transform blocks, and
wherein the transforming transforms each two-dimensional transform block into a transform coefficient block with a transform.

5. The method of claim 4, wherein the transform includes but is not limited to the two-dimensional Discrete Cosine Transform, two-dimensional Discrete Wavelet Transform, and two-dimensional Discrete Fourier Transform.

6. The method of claim 1
wherein each transform block includes a three-dimensional transform block that is a rectangular cuboid or cube pixel block with W pixels wide by H pixels high by L pixels long, where W, H and L are positive integers larger than 1,
wherein the dividing divides the video into one or a plurality of video segments, each video segment including a plurality of temporally consecutive video frames and each video segment further being divided into one or a plurality of three-dimensional transform blocks, and
wherein the transforming transforms each three-dimensional transform block into a transform coefficient block with a transform.

7. The method of claim 6, wherein the transform includes but is not limited to the three-dimensional Discrete Cosine Transform, three-dimensional Discrete Wavelet Transform, and three-dimensional Discrete Fourier Transform.

8. The method of claim 1, further comprising digital quantizing the transform coefficients in each transform coefficient block according to one or a plurality of digital quantization tables, each digital quantization table including one or a plurality of quantization steps that are real positive numbers, which comprising:
dividing each transform coefficient by a quantization step from a quantization table; and
converting the result of the dividing into an integer by methods including but not limited to rounding.

9. The method of claim 1, further comprising digital zeroing the transform coefficients in each transform coefficient block according to one or a plurality of digital quantization tables, each digital quantization table including one of a plurality of quantization steps that are real non-negative numbers, which comprising:
zeroing each transform coefficient whose magnitude is less than a quantization step from a quantization table; and
keeping each transform coefficient whose magnitude is not less than the quantization step from the quantization table unmodified.

10. The method of claim 1,
further comprising normalizing the transform coefficients, which comprising: grouping the transform coefficients into one or a plurality of normalization regions, each normalization region including a plurality of transform coefficients; and multiplying each transform coefficient in each normalization region by a scaling factor that is a real positive number and is same to each transform coefficient in the same normalization region but may be different for different normalization regions,
wherein the mapping includes the scaling factor of each normalization region as digital data in a to-be-modulated signal frame.

11. The method of claim 1,
further comprising normalizing the samples of the transmission signal, which comprising:
grouping the transmission signal frames into one or a plurality of normalization regions, each normalization region including one or a plurality of transmission signal frames; and multiplying each sample in each normalization region by a scaling factor that is a real positive number and is same to each sample in the same normalization region but may be different for different normalization regions,
wherein the mapping includes the scaling factor of each normalization region as digital data in a to-be-modulated signal frame.

12. The method of claim 1, wherein the mapping comprising:
grouping a plurality of transform coefficients into a transmission region;
reordering all transform coefficients in transmission region into a region coefficient array that is one-dimensional array according certain order including but not limited to: transform coefficient with lower transform frequency appearing earlier, and transform coefficient with larger magnitude appearing earlier; and
including the region coefficient array in the to-be-modulated signal frame.

13. The method of claim 1, wherein the mapping comprising:
grouping a plurality of non-zero transform coefficients into a transmission region;
reordering all transform coefficients in transmission region into a region coefficient array that is one-dimensional array according certain order including but not limited to: non-zero transform coefficient with lower transform frequency appearing earlier, and non-zero transform coefficient with larger magnitude appearing earlier;
including the region coefficient array in the to-be-modulated signal frame; and
including the position information in digital data in a to-be-modulated signal frame, upon the position information one being able to determine the position of all non-zeroed coefficients.

14. The method of claim 1, wherein a quasi-continuous value is a digital value produced either by quantization of a continuous value with limited number of bits to obtain a digital approximate of the continuous value with a discrete value from a set of discrete values that are determined by the limited number of bits, or by computation involving one or multiple quasi-continuous values.

15. The method of claim 1, wherein the modulating includes but is not limited to modulating a to-be-modulated signal frame by a modulation involving OFDM, comprising:
mapping the digital data into one or a plurality of OFDM frequency bins by certain digital modulation if the digital data are included in the to-be-modulated signal frame;
assigning the transform coefficients included in the to-be-modulated signal frame into one or a plurality of the OFDM frequency bins without digital modulation;
transform the OFDM symbol to a time-domain signal frame; and
generating a transmission signal frame by inserting Cyclic Prefix, Cyclic Suffix, Zero Padding or nothing to the time-domain signal frame.

16. The method of claim 15, wherein the OFDM symbol includes at least one continuous frequency bin whose real part or imaginary part or both are continuous-valued transform coefficients.

17. The method of claim 15, wherein the OFDM symbol includes at least one quasi-continuous frequency bin whose real part or imaginary part or both are quasi-continuous-valued transform coefficients.

18. The method of claim 1, wherein, the modulating includes but is not limited to modulating a to-be-modulated signal frame by a modulation involving CDMA, comprising:
mapping the digital data into one or plurality of spreading sequences and modulating the spreading sequences by certain digital modulation if the digital data are included in the to-be-modulated signal frame;
assigning the transform coefficients into the spreading sequences without digital modulation and modulating each spreading sequence assigned with one or a pair of transform coefficients by multiplying the sequence with the assigned number which is either a real number that is the assigned transform coefficient or a complex number which includes the pair of transform coefficients as real part and imaginary part; and
generating transmission signal frame by summing all modulated sequences.

19. The method of claim 18, wherein at least one spreading sequence is modulated by a signal value whose real part or imaginary part or both are continuous-valued transform coefficients.

20. The method of claim 18, wherein at least one spreading sequence is modulated by a signal value whose real part or imaginary part or both are quasi-continuous-valued transform coefficients.
